(19) United States
(12) Patent Application Publication
(10) Pub. No.: US 2008/0008381 A1
(43) Pub. Date: Jan. 10, 2008

(54) Coordinate acquisition apparatus for test of printed board, and coordinate acquisition method and program for test thereof

(75) Inventors: Yasunori Ushio, Kawasaki (JP); Mikio Hara, Kawasaki (JP); Yoshiko Yamaguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/588,408

(22) Filed: Oct. 27, 2006

(30) Foreign Application Priority Data
Jul. 7, 2006 (JP) 2006-187663

(51) Int. Cl. G06K 9/00; G06K 9/36

(52) U.S. Cl. 382/147; 382/287; 382/153

(57) ABSTRACT

The present invention has been made to obtain a coordinate acquisition apparatus for test of a printed board that can automatically generate coordinates required for performing the clip test from a predetermined target object formed in a printed board to thereby automate the clip test.

A coordinate acquisition apparatus for test of a printed board comprises: a camera that photographs a printed board; a target object detection section that uses pattern matching to detect a predetermined target object formed in the printed board from image data photographed by the camera; and a coordinate position acquisition section that acquires the coordinate position of the target object detected by the target object detection section with respect to the printed board.

### BACKGROUND OF THE INVENTION

1. Field of the Invention

The present invention relates to a coordinate acquisition apparatus for test of a printed board and a coordinate acquisition method and program for test thereof that are applied to a pseudo-fault generation apparatus, which performs a clip test such as one using a robot arm or the like to establish electrical continuity between predetermined vias formed in a printed board to thereby generate a pseudo-fault so as to test the printed board, and detect a clipping object and the position thereof by means of image processing.

2. Description of the Related Art

A pseudo-fault generation apparatus, which performs a clip test such as one using a robot arm or the like to establish electrical continuity between predetermined vias formed in a printed board to thereby generate a pseudo-fault so as to test the printed board, requires, numeric data of, e.g., via coordinates (refer to, e.g., Patent Document 1: Jpn. Pat. Appln. Laid-Open Publication No. 2002-280800). In the case where a printed board to be test is made by our company, the via coordinates are acquired from CAD information.

As a conventional art related to the present invention, there is known a technique that inputs an image of a printed board and analyzes a pattern on the printed board, as well as, inputs data including information about the mounting position of electronic components on the printed board from outside and corrects the mounting position data to practical data indicating the position where the electronic components are actually mounted (refer to, e.g., Patent Document 2: Jpn. Pat. Appln. Laid-Open Publication No. 3-191600).

As described above, data of a printed board made by our company can be acquired from the CAD information in the abovementioned clip test, whereas it is impossible to acquire the coordinate data for performing the clip test in the case where a printed board is not designed by our company. Further, there has been no technique for automatically acquiring the coordinate data with high accuracy.

Therefore, such a clip test has been manually performed, resulting in high labor cost.

### SUMMARY OF THE INVENTION

The present invention has been made to solve the above problem, and an object thereof is to provide a coordinate acquisition apparatus for test of a printed board and a coordinate acquisition method and program for test thereof that can automatically generate coordinates required for performing the clip test from a predetermined target object formed in a printed board to thereby automate the clip test.

To solve the above problem, according to a first aspect of the present invention, there is provided a coordinate acquisition apparatus for test of a printed board which comprises: an image pickup device that photographs a printed board; a target object detection section that uses pattern matching to detect a predetermined target object formed in the printed board from image data photographed by the image pickup device; and a coordinate position acquisition section that acquires the coordinate position of the target object detected by the target object detection section with respect to the printed board.

In the coordinate acquisition apparatus for test of a printed board according to the present invention, the target object detection section includes a registration section that previously registers a pattern of the target object to be detected from the printed board using the pattern matching.

In the coordinate acquisition apparatus for test of a printed board according to the present invention, the registration section detects a plurality of target objects, each of which is distinguished from a base of the printed board and has an area partitioned from the base, as choices of the target objects, creates an image for each area, and presents the image of the choices of the target object to a user to allow the user to specify a desired target object to acquire a pattern of the target object.

The coordinate acquisition apparatus for test of a printed board according to the present invention comprises a drive section that drives at least one of the image pickup device and printed board to allow the image pickup device to photograph the printed board having a larger size than that of the visual field of the image pick up device while dividing the entire area of the printed board into multiple pieces.

In the coordinate acquisition apparatus for test of a printed board according to the present invention, in a single operation, the drive section drives the image pickup device or printed board in the drive direction by a distance corresponding to the length obtained by subtracting the actual size specified by a parameter indicating the size of the target object from the actual length of the area of one entire photographed image, and the target object detection section uses pattern matching to detect the target object at each stationary position of the image pickup device or printed board.

In the coordinate acquisition apparatus for test of a printed board according to the present invention, the drive section drives the image pickup device or printed board in the direction perpendicular to the main scanning direction of the image pickup device.

In the coordinate acquisition apparatus for test of a printed board according to the present invention, the drive section drives the image pickup device or printed board in a continuous manner, and the target object detection section performs the pattern matching using a part of the area of the photographed image which covers a predetermined range in both the main- and sub-scanning directions.

In the coordinate acquisition apparatus for test of a printed board according to the present invention, the area to be used in the pattern matching can be changed depending on the size of the predetermined target object to be registered by the registration section.

According to a second aspect of the present invention, there is provided a coordinate acquisition method for test of a printed board comprising: a photographing step that photographs a printed board using an image pickup device; a detection step that uses pattern matching to detect a predetermined target object formed in the printed board from image data photographed by the image pickup device; and a coordinate acquisition step that acquires the coordinate position of the detected target object with respect to the printed board.

According to a third aspect of the present invention, there is provided a coordinate acquisition program for test of a printed board allowing a computer to execute a method of detecting a predetermined target object formed in the printed board and acquiring the coordinates of the target object, comprising: a photographing step that photographs a printed board using an image pickup device; a detection step that uses pattern matching to detect a predetermined target object formed in a printed board from image data photographed by the image pickup device; and a coordinate acquisition step that acquires the coordinate position of the detected target object with respect to the printed board.

According to the present invention, it is possible to automatically generate coordinates required for performing the clip test of a printed board to thereby automate the clip test.

### BRIEF DESCRIPTION OF THE DRAWINGS

FIG. 1 is a block diagram of a first embodiment of the present invention;

FIG. 2 is the entire configuration view of the first embodiment of the present invention;

FIG. 3 is a flowchart showing the entire operation of the first embodiment;

FIG. 4 is a flowchart showing a master via registration operation according to the first embodiment performed by a user;

FIG. 5 is a flowchart showing a calibration operation according to the first embodiment;

FIG. 6 is an explanatory view of the calibration operation;

FIG. 7 is an explanatory view of the movement amount of the camera;

FIG. 8 is a flowchart showing a camera movement calculation operation; and

FIG. 9 is an explanatory view of operation according to a third embodiment of the present invention.

### DETAILED DESCRIPTION OF THE PREFERRED EMBODIMENTS

Embodiments of the present invention will be described below with reference to the accompanying drawings. In the present embodiment, a predetermined via is detected from a printed board and the coordinates thereof is generated as via coordinated data.

In a clip test performed in a pseudo-fault generation apparatus, an accuracy of 1/100 millimeters is required for a coordinate position. In order for acquired via coordinate data to meet the accuracy required for the clip test, the present embodiment comprises photographing a printed board from above using an image pickup device (camera) in such a manner as to divide the image of the printed board into a plurality of pieces and converting the coordinate data of the via which has been recognized by a pattern matching with a previously registered via shape from a pixel coordinate value to actual measurement value (millimeter).

Hereinafter, a detailed description will be made using the drawings.

### First Embodiment

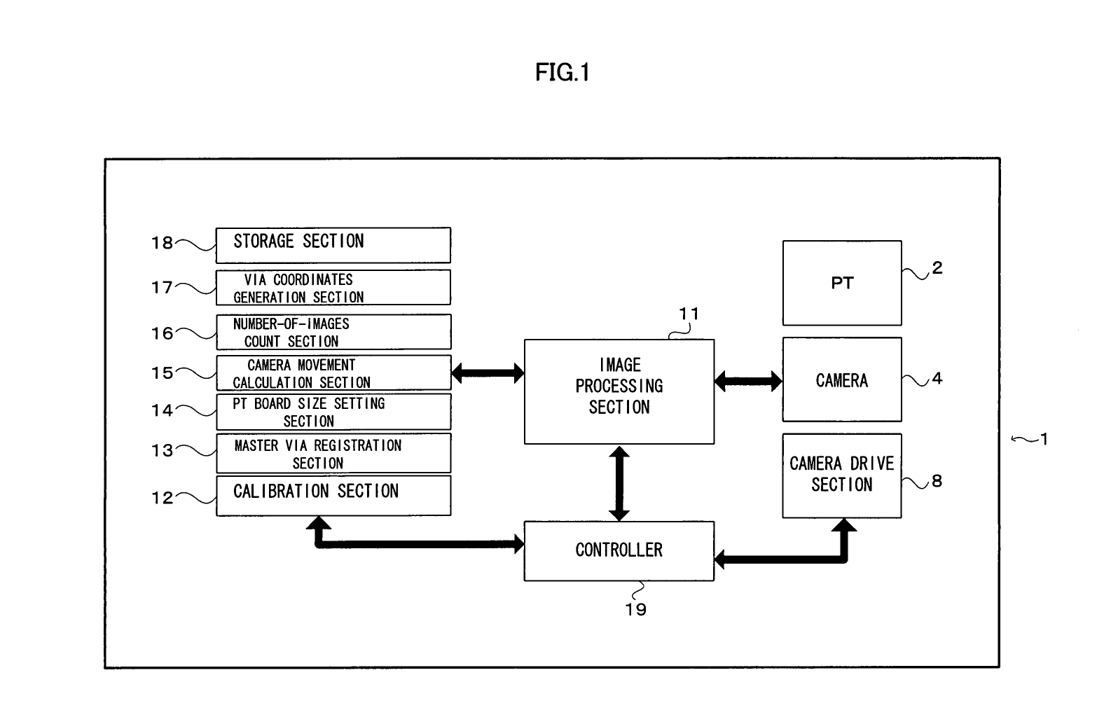

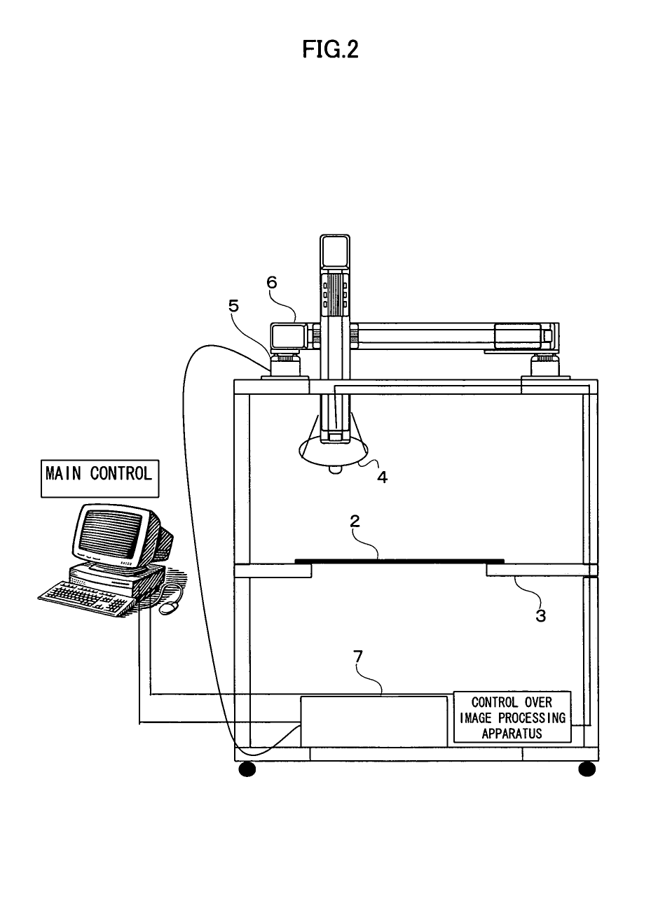

FIG. 1 is a block diagram according to a first embodiment of the present invention. FIG. 2 is the entire configuration view thereof. A printed board coordinate data generation apparatus 1 according to the first embodiment includes a support 3 on which a to-be-tested printed board 2 is horizontally placed, a camera 4 (image pickup device of the present invention) that photographs the printed board 2 from vertically above, and a camera drive section 8 (including a two-axis controller 7) that can move the camera 4 in the horizontal direction using X- and Y-axis robots 5 and 6 so that the camera 4 can cover the entire area to be imaged on the printed board 2.

The printed board coordinate data generation apparatus 1 of the first embodiment further includes an image processing section 11 that applies predetermined processing to an imaging signal acquired from the camera 4, a calibration section 12 that performs calibration for the camera 4 using the image processing section 11, a master via registration section 13 that registers a master via to be detected among a plurality of vias formed in the printed board 2, a printed board size setting section 14 that sets the size of the printed board 2, a camera movement calculation section 15 that detects the movement of the camera, a number-of-images count section 16 that counts the number of images, a via coordinates generation section 17 that generates the coordinates of the detected via in a predetermined format, a storage section 18 that stores the generated via coordinates, and a controller 19 that controls the above components.

The details of the above components will be described below while focusing on the operation of the first embodiment.

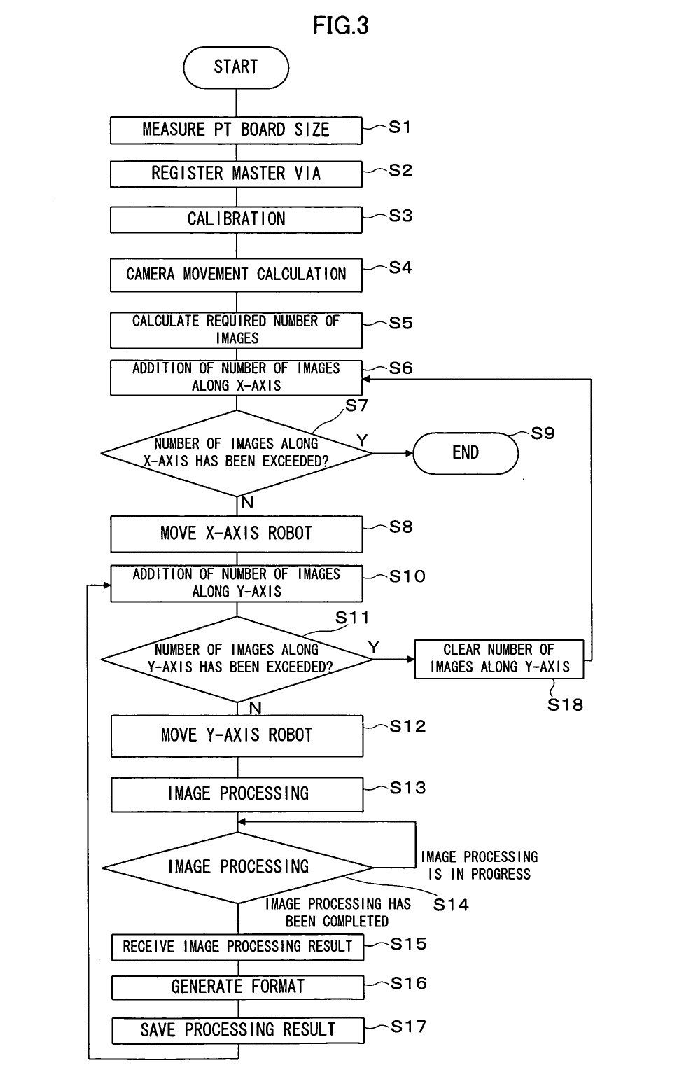

FIG. 3 is a flowchart showing the entire operation of the first embodiment. Firstly, when the operation is started after the printed board is placed on the apparatus, the size of the printed board is measured (S1). In this measurement, with the printed board 2 held by the support 3, the printed board size setting section 14 acquires the size of the printed board in X and Y directions.

There are a variety of sizes and shapes of the printed board 2 to be measured. In order to perform minimum distance pattern matching for such printed board 2, the size and height of the printed board 2 are previously obtained by camera movement and from a photographed image.

Then, registration of a master via is performed. More specifically, the master via registration section 13 registers the shape of the master via (registration via) from the photographed image taken by the camera 3. The master via thus registered serves as a base pattern for the following target via detection (recognition) processing which uses the pattern matching (S2). In the first embodiment, a user specifies a predetermined via while driving the camera 4 to acquire an image of the target via.

The master via registration section 13 prompts the user to specify a predetermined via (more specifically, prompts the user to specify the boundary of the via on the image) and registers the user's specified image.

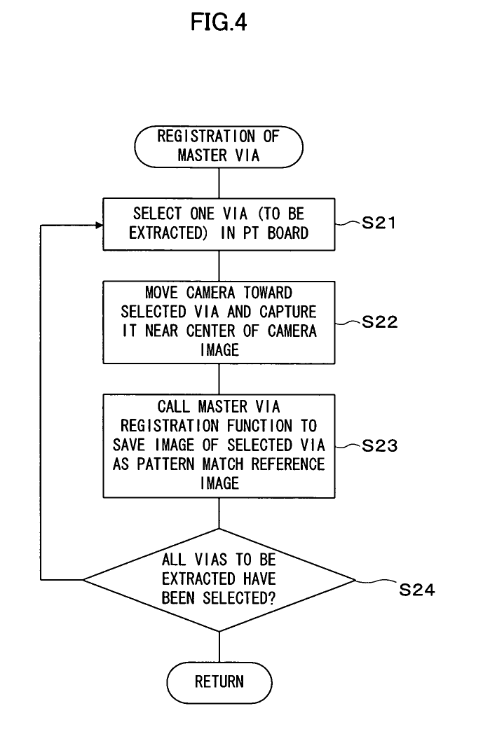

FIG. 4 is a flowchart showing the master via registration operation. Firstly, a user selects one via (to be extracted) in the printed board (S21). The user then moves the camera toward the selected via and visually captures it near the center of the image of the camera (S22). At this time, the user calls a master via registration function to save the image of the selected via as a pattern match reference image (S23). The above procedure is performed for all the vias to be extracted (S24).

As described above, the above master via registration operation allows the vias of various sizes existing on the printed board to be registered individually. Further, the pattern matching allows the registration vias to be individually detected from the photographed image and the coordinates and type of the detected via to be output.

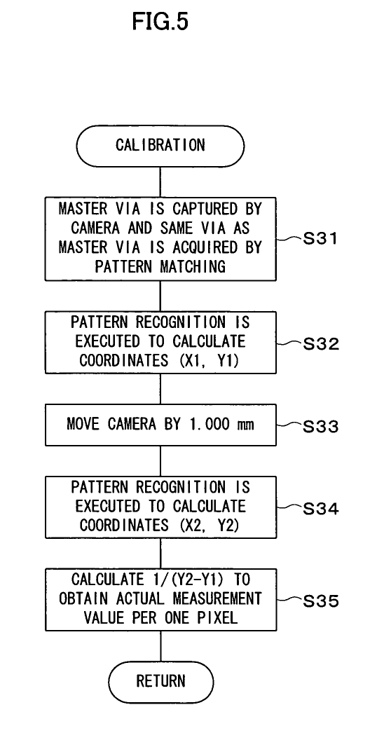

After completion of the registration of vias, the calibration is performed (S3). More specifically, the calibration section 12 calculates a conversion value for measuring the actual value (millimeter) of the coordinates. The actual value of one pixel in the image varies depending on the photographing magnification. Accordingly, a method shown in a flowchart of FIG. 5 is used.

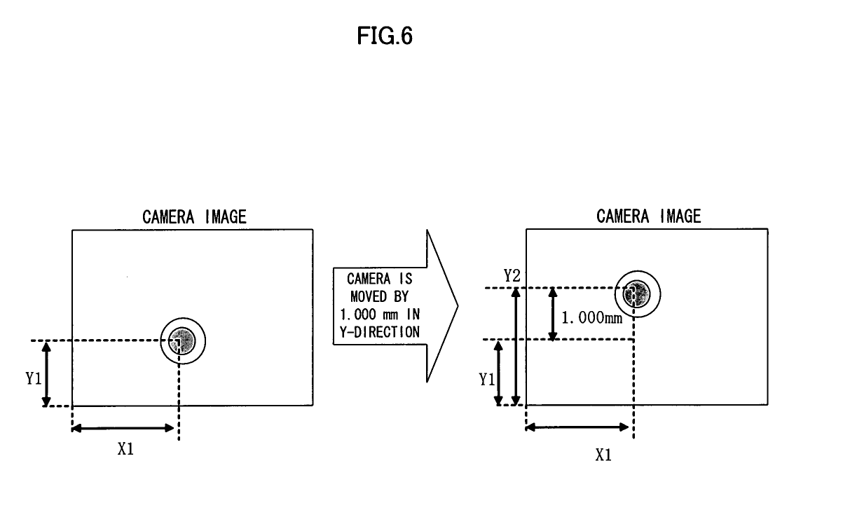

Firstly, the same via as a given via that has been registered as a master via is acquired from a given photographed image by pattern matching (S31). Then, the coordinates (X1, Y1) of the acquired via are calculated (S32). Then, the camera position is moved by 1.000 mm in one direction (e.g., Y-direction) (S33). Then, the same via as above is acquired once again from the photographed image and coordinates thereof (X2, Y2) are calculated (S34). After that, as shown in FIG. 6, an actual measurement value per one pixel is calculated from a difference (pixel value) between the result of (S2) and that of (S4) (S35).

After completion of the calibration, the movement amount of the camera is detected based on the calibration operation (S4). More specifically, the camera movement calculation section 15 detects the amount of the movement of the camera based on the printed board size and conversion value (pixel/millimeter). In order to capture a via incompletely existing at the boundary of the camera image, the camera is moved such that the current and next images are overlapped with each other by a distance corresponding to the diameter of the master via.

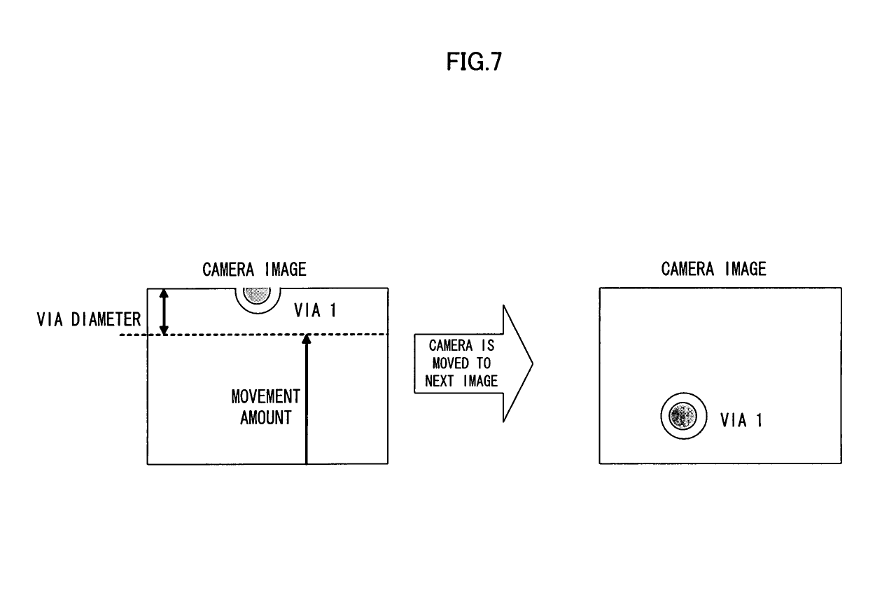

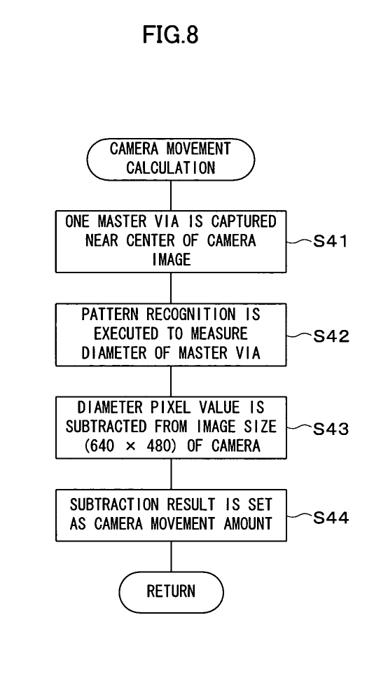

The movement of the camera at this time is shown in FIG. 7. FIG. 8 is a flowchart showing camera movement detection operation. Firstly, with one master via captured near the center of the camera image (S41), pattern recognition is executed to measure the diameter of the master via (S42). Then, the pixel number corresponding to the diameter is subtracted from the image size of the camera (S43), and the subtraction result is set as the camera movement amount (S44).

The required number of images is calculated from the obtained camera movement amount (S5). After that, pattern matching processing is performed the number of times corresponding to the calculated number of images while the camera is moved in a stepwise manner.

After the camera position is fixed to one image position along X-axis (first axis) (S6, S7, and S8), the camera is sequentially moved to all the photographing positions along Y-axis for photographing of images (S10, S11, and S12). Then, image processing is sequentially performed (S13 and S14) to acquire the coordinates of vias each having the same pattern as that of the master via (S15). The coordinates of each via are output in a predetermined format (S16) and saved (S17). After completion of processing for all the photographing positions along Y-axis (S11 and S18), the camera is moved to the next position along X-axis (S6, S7, and S8) for repetition of the same processing. Since the pattern matching processing itself is a known technique, description thereof is omitted here.

As described above, all the target via coordinates on the printed board 2 having the size larger than the photographed area of the camera can be obtained with high accuracy. Although the coordinates of the same via as the master via is obtained in the present embodiment, it is possible to obtain the coordinates of not only via but also of a land or various patterns.

### Second Embodiment

In the first embodiment, all the operations for the master via registration (from camera movement operation to specification of the master via) are carried out by a user. In the second embodiment, the apparatus side automatically acquires vias and presents them to the user as a list or in a sequential manner on a control screen. Thus, at the master via registration time, it is sufficient for the user to simply specify a desired via.

For example, the master via registration section 13 photographs the entire area of the printed board with a camera based on the size of the printed board. After that, a pattern of some kind is formed for the base zone of the printed board based on the photographed image. Then the master via registration section 13 detects the area different from the base zone using the formed pattern as well as creates images of the detected areas, i.e., areas partitioned from the base zone as choices of target objects and lists them. The list is then presented to the user on a screen to allow him or her to specify a desired target object. This configuration extremely simplifies the user's via registration operation.

### Third Embodiment

In the first embodiment, the camera is moved in a stepwise manner so that the camera's photographing function at the stationary state is used as a memory. If the apparatus has an image memory, the camera may be moved in a continuous manner.

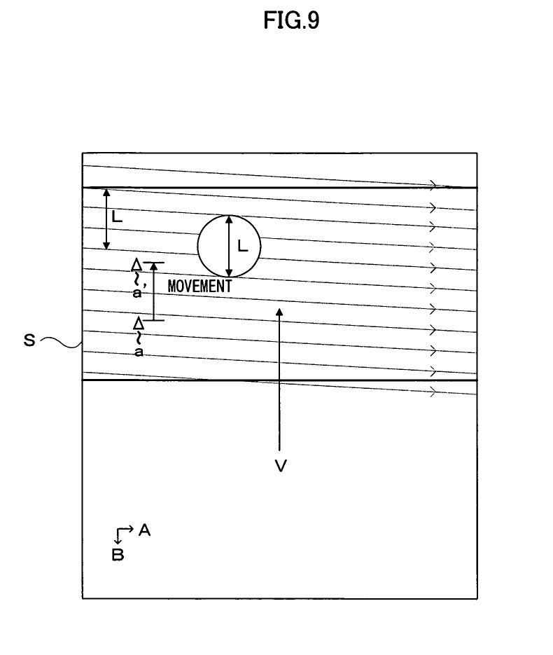

In this case, as shown in FIG. 9, the drive section drives the camera in the direction perpendicular to the main scanning direction and thereby the usage of the image data can be improved. That is, some large amount of image data photographed by the main scanning can be obtained every time one main scanning operation is completed, with the result that the time required to acquire the image data can be reduced than in the case where the camera is driven in the sub-scanning direction.

The abovementioned continuous movement of the camera can be enabled if there is a relationship between image processing speed and camera movement speed such that at the time when one image to be processed is photographed (acquired), a printed board end edge a photographed and positioned at one end of the image is still being photographed (in the subsequent image to be processed) at a position a′ which is away from the other end edge of this image in the direction toward the one end edge by a distance corresponding to the size (L) of a target object.

Further, if the above relationship is satisfied, it becomes possible to use a part of the photographed area (S) (not the entire photographed area) as shown in FIG. 9, depending on the size of the via serving as a target object. This eliminates the need to use a large image pickup device and a large-capacity memory, contributing to miniaturization of the camera and reduction in manufacturing cost thereof.

Accordingly, the photographed area to be used can be changed depending on the size of the predetermined target object registered by the master via registration section. This reduces the amount of data to be handled in one processing to thereby simplify the calculation as well as reduces a required memory capacity.

In the present invention, the computer-readable medium mentioned here includes: a portable storage medium such as a CD-ROM, a flexible disk, a DVD disk, a magneto-optical disk, or an IC card; a database that holds computer program; another computer and database thereof; and a transmission medium on a network line.

What is claimed is:

1. A coordinate acquisition apparatus for test of a printed board, comprising:
an image pickup device that photographs a printed board;
a target object detection section that uses pattern matching to detect a predetermined target object formed in the printed board from image data photographed by the image pickup device; and
a coordinate position acquisition section that acquires the coordinate position of the target object detected by the target object detection section with respect to the printed board.

2. The coordinate acquisition apparatus for test of a printed board according to claim 1, wherein
the target object detection section includes a registration section that previously registers a pattern of the target object to be detected from the printed board using the pattern matching.

3. The coordinate acquisition apparatus for test of a printed board according to claim 2, wherein
the registration section detects a plurality of target objects, each of which is distinguished from a base of the printed board and has an area partitioned from the base, as choices of the target objects, creates an image for each area, and presents the image of the choices of the target object to a user to allow the user to specify a desired target object to acquire a pattern of the target object.

4. The coordinate acquisition apparatus for test of a printed board according to claim 1, comprising a drive section that drives at least one of the image pickup device and printed board to allow the image pickup device to photograph the printed board having a larger size than that of the visual field of the image pick up device while dividing the entire area of the printed board into multiple pieces.

5. The coordinate acquisition apparatus for test of a printed board according to claim 4, wherein
in a single operation, the drive section drives the image pickup device or printed board in the drive direction by a distance corresponding to the length obtained by subtracting the actual size specified by a parameter indicating the size of the target object from the actual length of the area of one entire photographed image, and
the target object detection section uses pattern matching to detect the target object at each stationary position of the image pickup device or printed board.

6. The coordinate acquisition apparatus for test of a printed board according to claim 4, wherein
the drive section drives the image pickup device or printed board in the direction perpendicular to the main scanning direction of the image pickup device.

7. The coordinate acquisition apparatus for test of a printed board according to claim 6, wherein
the drive section drives the image pickup device or printed board in a continuous manner, and
the target object detection section performs the pattern matching using a part of the area of the photographed image which covers a predetermined range in both the main- and sub-scanning directions.

8. The coordinate acquisition apparatus for test of a printed board according to claim 7, wherein
the area to be used in the pattern matching can be changed depending on the size of the predetermined target object to be registered by the registration section.

9. A coordinate acquisition method for test of a printed board, comprising:
a photographing step that photographs a printed board using an image pickup device;
a detection step that uses pattern matching to detect a predetermined target object formed in the printed board from image data photographed by the image pickup device; and
a coordinate acquisition step that acquires the coordinate position of the detected target object with respect to the printed board.

10. The coordinate acquisition method for test of a printed board according to claim 9, further comprising a registration step that previously registers a pattern of the target object which is used in the pattern matching performed in the detection step and thereby detected from the printed board.

11. The coordinate acquisition method for test of a printed board according to claim 10, wherein
the registration step detects a plurality of target objects, each of which is distinguished from a base of the printed board and has an area partitioned from the base, as choices of the target objects, creates an image for each area, and presents the image of the choices of the target object to a user to allow the user to specify a desired target object to acquire a pattern of the target object.

12. The coordinate acquisition method for test of a printed board according to claim 9, comprising a drive step that drives at least one of the image pickup device and printed board to allow the image pickup device to photograph the printed board having a larger size than that of the visual field of the image pick up device while dividing the entire area of the printed board into multiple pieces.

13. The coordinate acquisition method for test of a printed board according to claim 12, wherein
the drive step drives the image pickup device or printed board in a stepwise manner,
the drive step drives, in a single operation, the image pickup device or printed board in the drive direction by a distance corresponding to the length obtained by subtracting the actual size specified by a parameter indicating the size of the target object from the actual length of the area of one entire photographed image, and
the detection step uses pattern matching to detect the target object at each stationary position of the image pickup device or printed board.

14. The coordinate acquisition method for test of a printed board according to claim 12, wherein
the drive step drives the image pickup device or printed board in the direction perpendicular to the main scanning direction of the image pickup device.

15. The coordinate acquisition method for test of a printed board according to claim 14, wherein
the drive step drives the image pickup device or printed board in a continuous manner, and
the detection step performs the pattern matching using a part of the area of the photographed image which covers a predetermined range in both the main and sub-scanning directions.

16. The coordinate acquisition method for test of a printed board according to claim 15, wherein
the area to be used in the pattern matching can be changed depending on the size of the predetermined target object to be registered by the registration step.

17. A coordinate acquisition program for test of a printed board allowing a computer to execute a method of detecting a predetermined target object formed in the printed board and acquiring the coordinates of the target object, comprising:
a photographing step that photographs a printed board using an image pickup device;
a detection step that uses pattern matching to detect a predetermined target object formed in a printed board from image data photographed by the image pickup device; and
a coordinate acquisition step that acquires the coordinate position of the detected target object with respect to the printed board.

18. The coordinate acquisition program for test of a printed board according to claim 17, further comprising a registration step that previously registers a pattern of the target object which is used in the pattern matching performed in the detection step and thereby detected from the printed board.

19. The coordinate acquisition program for test of a printed board according to claim 18, wherein
the registration step detects a plurality of target objects, each of which is distinguished from a base of the printed board and has an area partitioned from the base, as choices of the target objects, creates an image for each area, and presents the image of the choices of the target object to a user to allow the user to specify a desired target object to acquire the pattern of a target object.

20. The coordinate acquisition program for test of a printed board according to claim 17, comprising a drive step that drives at least one of the image pickup device and printed board to allow the image pickup device to photograph the printed board having a larger size than that of the visual field of the image pick up device while dividing the entire area of the printed board into multiple pieces.
